(19) United States
(12) Patent Application Publication
(10) Pub. No.: US 2013/0342074 A1
(43) Pub. Date: Dec. 26, 2013

(54) STATOR-FIXED STRUCTURE AND DRIVING UNIT

(71) Applicants: Tomonari Shiraishi, Shizuoka (JP); Toshihiko Nagata, Shizuoka (JP); Toshihide Ootani, Shizuoka (JP)

(72) Inventors: Tomonari Shiraishi, Shizuoka (JP); Toshihiko Nagata, Shizuoka (JP); Toshihide Ootani, Shizuoka (JP)

(73) Assignee: YAMAHA MOTOR ELECTRONICS CO., LTD., Shuchi-gun, Shizuoka (JP)

(21) Appl. No.: 14/003,295

(22) PCT Filed: Feb. 21, 2012
(86) PCT No.: PCT/JP2012/001153

§ 371 Date: Sep. 5, 2013

(30) Foreign Application Priority Data
Mar. 9, 2011 (JP) 2011-051684

(51) Int. Cl. H02K 3/00

(52) U.S. Cl. CPC H02K 3/00
USPC 310/254.1

(57) ABSTRACT

A driving unit includes a stator, a housing, and a spring pin. The housing includes a tubular section and a plate section. The tubular section accommodates the stator and includes a first groove on an inner wall thereof. The plate section has a flat plate shape orthogonal or substantially orthogonal to a central axis of the tubular section, and projects from an outer surface of the tubular section. The first groove is disposed in a peripheral direction of the tubular section within an area facing a joining portion across the central axis, wherein the joining portion is a portion connecting the tubular section to the plate section.

### BACKGROUND OF THE INVENTION

1. Field of the Invention

The present invention relates to a stator-fixed structure and a driving unit. More particularly, the present invention is directed to techniques of fixing a stator to a housing.

2. Description of the Related Art

Conventionally, a motor or a generator has been known including a stator, a rotor in the interior of the stator, and a case accommodating the stator and the rotor. The stator is fixed to the case by bolts or screws. See, for example, Japanese Patent Publication No. H06-70523A. Otherwise, the stator is adhered to the case via an adhesive. Such has also been known.

Examples of the conventional art with the construction described above, however, have the following drawbacks. That is, fixing the stator to the case by bolts or the like takes much time for assembly since the bolts require fastening upon fixing the stator. Such an inconvenience may occur. Moreover, parts for fixing the stator by bolts or the like are required, and thus such parts may lead to another inconvenience of a complex construction. On the other hand, fixing the stator with an adhesive may lead to an inconvenience of increased time for assembly including a cure time for the adhesive. Moreover, working efficiency easily decreases due to adhesion of the adhesive to a hand or the like of an operator. Such an inconvenience may also occur.

### SUMMARY OF THE INVENTION

In view of the state of the art described above, a preferred embodiment of the present invention provides a stator-fixed structure and a driving unit with a simple construction that allows the stator to be fixed in a short period of time.

A preferred embodiment of the present invention includes a stator-fixed structure. The stator-fixed structure includes a stator, a housing including a tubular section accommodating the stator with a first groove on an inner wall thereof, and a fixing member fixing the stator to the housing by being pressed into the first groove to press the stator against the inner wall of the tubular section. The housing further includes a plate section having a planar shape orthogonal or substantially orthogonal to a central axis of the tubular section and projecting from an outer surface of the tubular section. The first groove is disposed in a peripheral direction of the tubular section within an area facing a joining portion across the central axis, wherein the joining portion is a portion connecting the tubular section to the plate section.

In the stator-fixed structure according to a preferred embodiment of the present invention, the stator is accommodated in the tubular section including the first groove provided on the inner wall thereof. The fixing member is pressed into the first groove. The fixing member presses against a portion of an outer wall of the stator. Accordingly, the fixing member presses the stator (more strictly, a portion opposite to the portion of the outer wall of the stator) against the inner wall. Then, a friction force is generated between the stator and the inner wall, and the friction force causes the stator to be held therein. As a result, shifting of the stator along the central axis of the tubular section is suitably prevented or reduced.

The stator-fixed structure described above does not use a bolt or the like for fixing the stator thus achieving a simple construction. In addition, the stator is fixed to the housing by merely pressing the fixing member into the first groove thus resulting in an enhanced working efficiency. The location of the stator is also fixed in a short period of time.

A preferred embodiment of the present invention further includes a plate section projecting outwardly from the tubular section. As a result, the rigidity (strength) of the tubular section varies in accordance with the positions of the tubular section in the peripheral direction. Specifically, a portion of the tubular section joined to the plate section has a higher rigidity than the other portions of the tubular section thus being difficult to deform and bend under a load. The first groove described above is disposed on an inner wall opposite to the inner wall corresponding to the joining portion of the tubular section and the plate section. Accordingly, an external surface (rear surface) of the inner wall against which the stator is pressed corresponds to the joining portion (a back surface of the inner wall corresponds to the joining portion). As described above, the portion of the tubular section with a relatively higher rigidity receives the load of the stator, and thus the shape of the tubular section is difficult to deform. Consequently, radial shifting the stator is prevented or reduced.

In a preferred embodiment of the present invention, the joining portion preferably overlaps the fixing member along the central axis. This leads to overlap of the joining portion along the central axis and the inner wall undergoing the load from the stator. As a result, the inner wall including the back surface as the joining portion receives the load from the stator. Consequently, deformation of the tubular section is suitably prevented or reduced.

In a preferred embodiment of the present invention, the joining portion is preferably disposed below an upper end surface of the tubular section along the central axis. This suitably prevents or reduces deformation of the tubular section.

In a preferred embodiment of the present invention, the joining portion preferably has a length in the peripheral direction of the tubular section of about one-fourth or more of an entire periphery of the tubular section, for example. This enhances the rigidity of the tubular section. In addition, a larger contact area of the stator and the inner wall can be obtained.

In a preferred embodiment of the present invention, the fixing member preferably has a columnar shape and is preferably pressed into the first groove with a shaft axis of the fixing member being parallel or substantially parallel to the central axis. Accordingly, variations in the force applied by the fixing member to the stator in accordance with positions of the fixing member along the central axis is suitably prevented or reduced.

In a preferred embodiment of the present invention, the fixing member is preferably cylindrical or substantially cylindrical. This causes a direction in which the fixing member presses the stator to conform to a radial direction from the first groove toward the central axis

In a preferred embodiment of the present invention, the fixing member is preferably a spring pin with a slit provided therein. The spring pin is preferably an elastic body. Consequently, variations in size of the stator and/or the tubular section is absorbed to permit the stator to be suitably pressed against the inner wall. Moreover, a smaller fixing member is obtained by using the spring pin. This achieves a smaller first groove thus allowing a reduction in the size of the tubular section.

In a preferred embodiment the present invention, it is preferable that the radial direction relative to the central axis through the shaft axis of the spring pin is orthogonal or substantially orthogonal to a direction of connecting the shaft axis to the slit. In other words, assuming that a direction orthogonal, as seen from the central axis, relative to a radial direction to the central axis through the shaft axis is a tangent line direction, a direction of connecting the shaft axis to the slit is parallel or substantially parallel to the tangent line. An elastic force generated by the spring pin sufficiently acts on the stator.

In a preferred embodiment of the present invention, the fixing member preferably has a length shorter than that of the stator along the central axis. This avoids projection of the fixing member from the stator. Consequently, interference between the fixing member and the stator or other elements can be suitably prevented or reduced.

In a preferred embodiment of the present invention, the stator includes a second groove on an outer wall thereof. The stator is accommodated in the tubular section such that the second groove opposes the first groove. The fixing member is pressed into a gap defined by the first groove and the second groove. Such a configuration is preferable. When the stator includes the second groove, the fixing member sufficiently presses against the stator. This ensures that the stator is fixed in the housing. In addition, preventing or reducing the shifting of the stator in the peripheral direction relative to the central axis is achieved in one operation.

A preferred embodiment of the present invention preferably includes a cover and an elastic member. The cover is coupled to the housing and blocks an opening of the tubular section. The elastic member is disposed between a top surface of the stator and a rear surface of the cover and presses the stator along the central axis and away from the cover. The elastic member presses the stator downwardly along the central axis to press the lower surface of the stator against the tubular section. This prevents or reduces shifting of the stator along the central axis.

In a preferred embodiment of the present invention, the tubular section includes a plurality of bosses projecting radially and outwardly from an upper end surface thereof to connect to the cover. The first groove is disposed adjacent to any one of the bosses. This increases the strength of a portion of the tubular section where the first groove is provided. Consequently, deformation of the portion of the tubular section where the first groove is provided is suitably prevented or reduced.

In a preferred embodiment of the present invention, the top surface of the stator preferably projects above the upper end surface of the tubular section. The cover includes inside thereof a notch provided along an extended position of the first groove. An upper portion of the stator is partially accommodated inside the cover thus facilitating a size reduction. In addition, the cover includes inside thereof the notch thus allowing the fixing member to project from the upper end surface of the tubular section.

Another preferred embodiment of the present invention includes a driving unit including a motor configured to generate power, the motor including a rotor and a stator outside of the rotor, a housing including a tubular section accommodating the motor, the tubular section including a first groove on an inner wall thereof, and a fixing member configured to fix the stator to the housing by being pressed into the first groove to press the stator against the inner wall of the tubular section. The housing further includes a plate section having a planar shape substantially orthogonal to a central axis of the tubular section and projecting from an outer surface of the tubular section. The first groove is disposed in a peripheral direction of the tubular section within an area facing a joining portion across the central axis, wherein the joining portion is a portion connecting the plate section to the tubular section.

The driving unit according to a preferred embodiment of the present invention includes the stator-fixed structure. This suitably prevents or reduces shifting of the stator along the central axis of the tubular section and radially relative to the central axis. Moreover, this achieves a simple structure of the driving unit. Furthermore, the stator is fixed to the housing by merely pressing the fixing member into the first groove thus leading to an enhanced working efficiency and assembly in a short period of time. Accordingly, efficient assembly of the driving unit can be achieved.

In a preferred embodiment of the present invention, the driving unit preferably is mounted on a bicycle. The housing further includes a crankshaft chamber into which a crankshaft of the bicycle is inserted. The motor generates power to assist a pressure on the pedals coupled to the crankshaft. Such a construction is preferable. The pedals of the bicycle often contact the ground first. The crankshaft is coupled the pedals. Accordingly, in the driving unit mounted on the bicycle, a shock may be applied directly to the housing, and may be applied indirectly inside the driving unit via the housing. In addition, a shock may be applied directly inside the driving unit (crankshaft chamber) via the crankshaft. In the latter, a strong force is applied to the stator along the central axis. The driving unit in a preferred embodiment of the present invention, however, includes the stator-fixed structure mentioned above, and thus shifting or disconnection of the stator along the central axis is suitably prevented or reduced. Consequently, the driving unit according to a preferred embodiment of the present invention is suitably applicable to bicycles, for example.

In a preferred embodiment of the present invention, the plate section is preferably a wall defining the crankshaft chamber. Since the plate section also serves as the crankshaft chamber, the driving unit has a simple construction.

In the stator-fixed structure according to a preferred embodiment of the present invention, the stator is accommodated in the tubular section including the inner wall with the first groove provided therein. The fixing member is pressed into the first groove. The fixing member presses a portion of the outer surface of the stator. This causes the fixing member to press a portion opposite to the portion of the stator against the inner wall. Then a friction force is generated between the stator and the inner wall thus holding the stator. Consequently, shifting of the stator along the central axis of the tubular section is suitably prevented or reduced.

A preferred embodiment of the present invention further includes the plate section projecting from outside of the tubular section. The first groove described above is disposed on an inner wall opposite to the inner wall as the joining portion of the tubular section and the plate section. Consequently, the fixing member presses the stator against a portion of the inner wall, the portion being reinforced by the plate section at the outside thereof. As described above, the tubular section receives a load from the stator on a portion having a relatively high rigidity thus leading to difficulty in deforming the tubular section. As a result, radial shifting of the stator relative to the central axis is prevented or reduced.

Accordingly, such a stator-fixed structure has a simple construction. In addition, the stator is fixed to the housing by merely pressing the fixing member into the first groove, resulting in an enhanced working efficiency. The stator is also fixed in a short period of time.

The driving unit according to a preferred embodiment of the present invention includes the stator-fixed structure. This suitably prevents or reduces shifting of the stator along the central axis of the tubular section and shifting radially relative to the central axis. Moreover, this achieves a simple construction of the driving unit. Furthermore, the stator is fixed to the housing by merely pressing the fixing member into the first groove, resulting in an enhanced working efficiency and performance in a short period of time. Accordingly, efficient assembly of the driving unit can be achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external view of a driving unit according to a preferred embodiment of the present invention.

FIG. 2 is a plan view of a principal portion of the driving unit.

FIG. 3 is a sectional view along arrow of III-III in FIG. 1.

FIG. 4 is a perspective view of a principal portion of a housing.

FIG. 5 is a perspective view of a principal portion of a stator.

FIG. 6 is an external perspective view of a spring pin.

FIG. 7 is an exploded perspective view of a principal portion of the driving unit.

FIG. 8 is an enlarged sectional view of a stator-fixed structure.

FIG. 9 is a perspective view of a rear surface of a cover.

FIG. 10 is an enlarged sectional view of a stator-fixed structure.

FIG. 11 is a perspective view of a bent wire rod.

FIG. 12A is a view of the bent wire rod illustrating a partial side view of the bent wire rod, and FIG. 12B is a view of the bent wire rod illustrating a plan view of the bent wire rod.

FIG. 13 is a left side view of a bicycle including the driving unit mounted thereon.

### DETAILED DESCRIPTION OF THE PREFERRED EMBODIMENTS

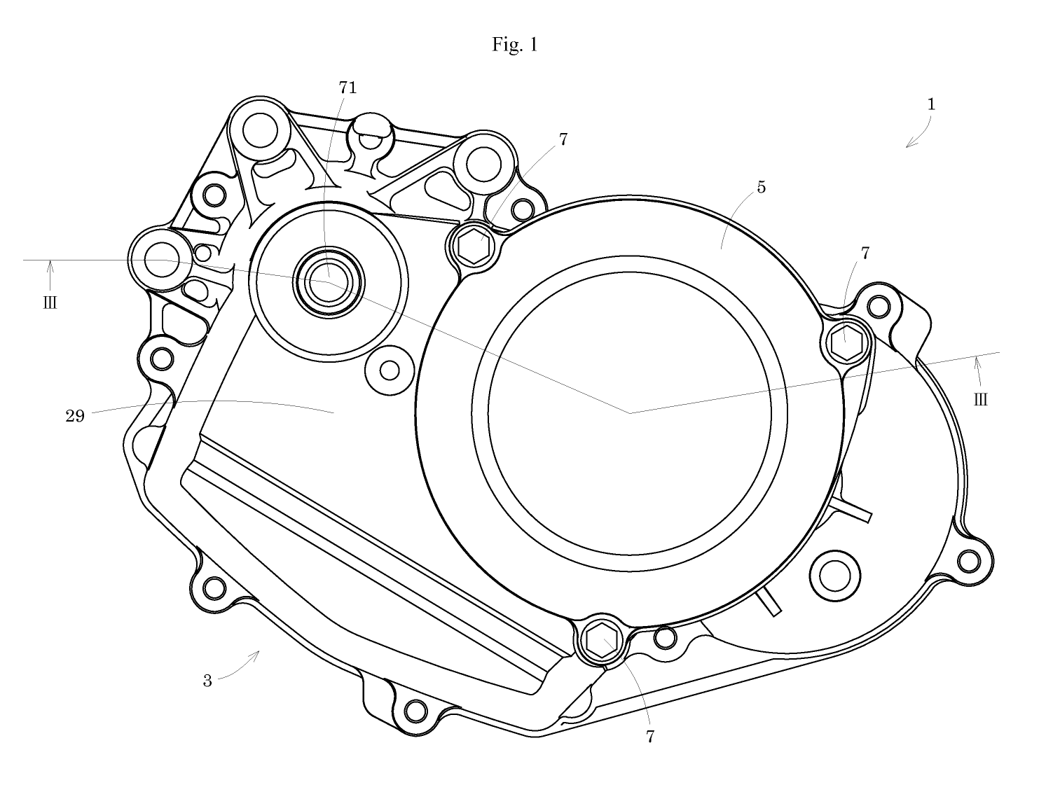

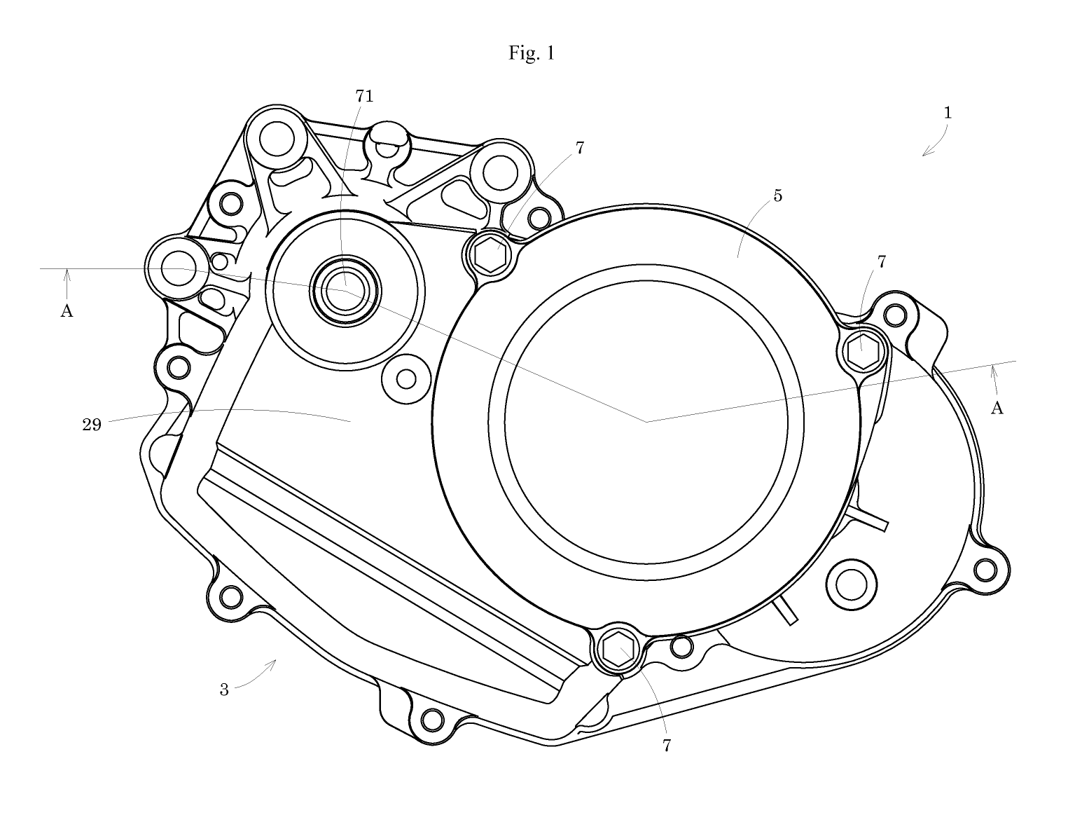

Description will be given hereinafter of preferred embodiments of the present invention with reference to drawings. A driving unit mountable on a bicycle will be described as one example of a preferred embodiment of the present invention. FIG. 1 is an external view of a driving unit according to a preferred embodiment of the present invention.

A driving unit 1 includes a housing 3 and a cover 5. The cover 5 is fastened to the housing 3 via bolts 7. A crankshaft 71 of a bicycle passes through the driving unit 1.

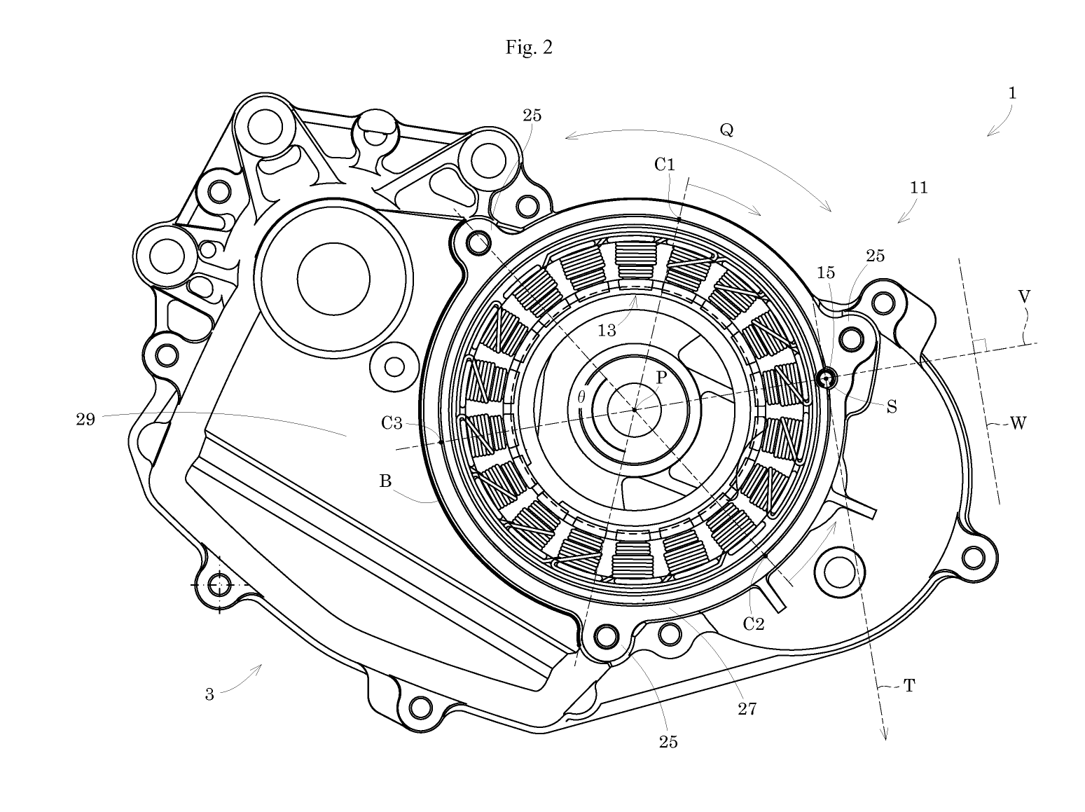

FIG. 2 is a plan view of a principal portion of the driving unit 1. In FIG. 2, besides the cover 5 and the crankshaft 71 described above, a rotor or the like is not shown. As illustrated, the housing 3 includes a tubular section 11 that is cylindrical or substantially cylindrical. The tubular section 11 includes a stator 13 accommodated therein. A spring pin 15 is pressed into a gap between the tubular section 11 and the stator 13.

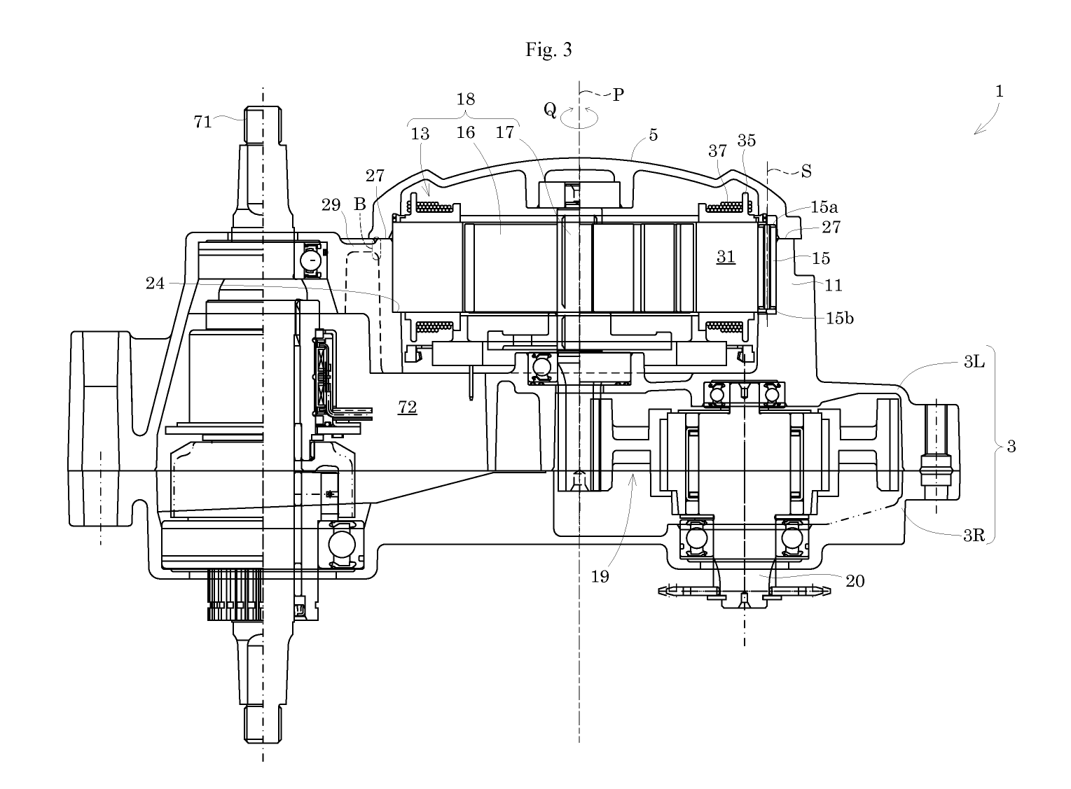

FIG. 3 is a sectional view along arrow of III-III in FIG. 1. As illustrated, a rotor 16 is disposed inside of the stator 13. The rotor 16 is connected to a rotary shaft 17 so as to rotate integrally with the rotary shaft 17. The rotary shaft 17 is rotatably supported in the housing 3. The stator 13, the rotor 16, and the rotary shaft 17 define a motor 18 that generates power. The rotary shaft 17 is interlocked with an output shaft 20 via a gear unit 19 or the like. The output shaft 20 outputs power generated by the motor 18.

The cover 5 described above blocks an upper opening of the tubular section 11. The cover 5 contacts an upper end surface 27 of the tubular section 11. The housing 3 includes a left case 3L and a right case 3R in which the left and right cases are separable from each other. Hereafter, description will be made simply of the housing 3 unless there is a difference between the left case 3L and the right case 3R.

In a preferred embodiment of the present invention, the term “central axis P” is used throughout the specification for convenience assuming that the central axis P of the tubular section 11 substantially conforms to an axis of the stator 13. In addition, in a preferred embodiment of the present invention, a direction along the central axis P from the tubular section 11 toward the cover 5 is referred to as an “upward direction along the central axis P” or “upward” for convenience. For instance, an upper side of the plane of FIG. 3 is referred to as an “upside direction along the central axis P” or simply as “upside”, whereas a lower side of the plane of the drawing is a “downside direction along the central axis P” or simply the “downside”. In addition, a direction around the central axis P is referred to as a “peripheral direction Q”.

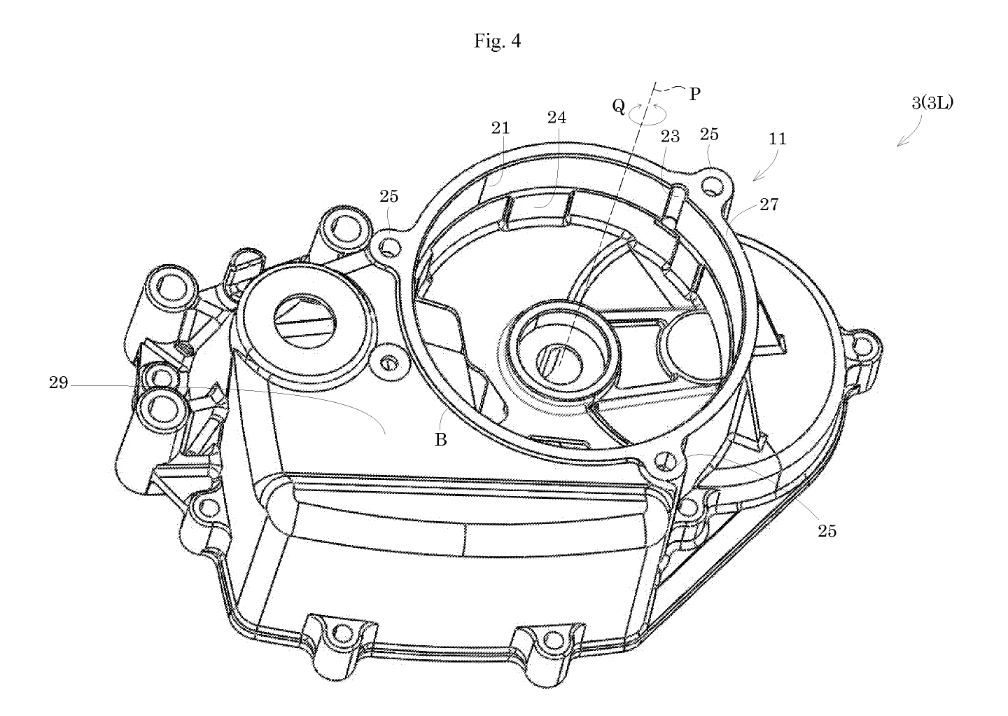

FIG. 4 is a perspective view of a principal portion of the housing 3. In FIG. 4, only the left case 3L is illustrated and the right case 3R is omitted.

As illustrated, the tubular section 11 includes an inner wall 21 on the inside thereof. The inner wall 21 has an internal diameter slightly larger than an external diameter of the stator 13, allowing accommodation of the stator 13. The inner wall 21 includes a single first groove 23 provided therein that is parallel or substantially parallel to the central axis P of the tubular section 11. The first groove 23 has a semicircular or substantially semicircular shape. In FIG. 4, the first groove 23 is disposed in a position slightly different from that in FIG. 2.

On lower ends of the inner wall 21 and the first groove 23, a flange 24 is provided that projects inwardly and radially relative to the central axis P (hereinafter abbreviated as “radially” where appropriate). The flange 24 has an internal diameter smaller than an external diameter of the stator 13. Atop surface of the flange 24 contacts a lower surface of the stator 13 to support the stator 13.

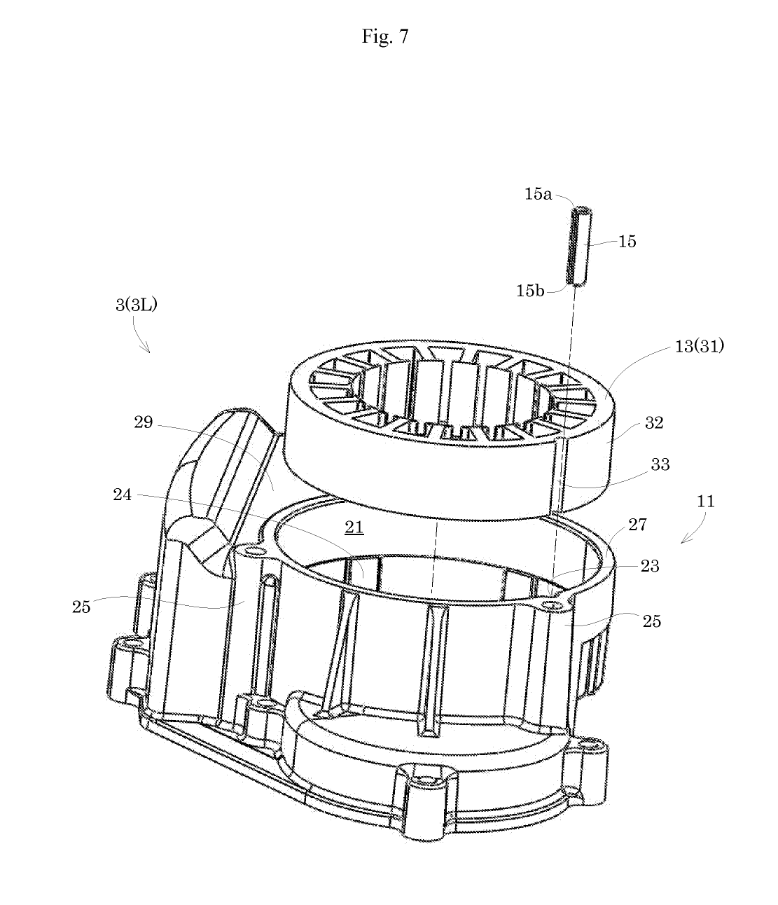

The tubular section 11 further includes a plurality of (e.g., three) bosses 25 to connect the cover 5 to the housing 3. The boss 25 projects radially and outwardly from the outside of the tubular section 11 (FIG. 7, to be described below, illustrates clearly the shape of the bosses 25). A projecting area (i.e., an area where the boss 25 is provided along the central axis P) extends downwardly from the upper end surface 27 of the tubular section 11. The first groove 23 described above is disposed adjacent to any one of the bosses 25 in the peripheral direction Q.

The housing 3 further includes a plate section 29 projecting externally from the tubular section 11. The plate section 29 has a planar shape orthogonal or substantially orthogonal to the central axis P. The plate section 29 is joined to the outer surface of the tubular section 11. The plate section 29 is joined to the tubular section 11 partially in the peripheral direction Q but not entirely. The tubular section 11 has a rigidity (strength) that varies in accordance with positions in the peripheral direction Q. Specifically, a portion of the tubular section 11 joined to the plate section 29 has a higher rigidity than that of the other portions, such that it is difficult to deform and bend under a load. Hereinafter, the portion where the tubular section 11 is joined to the plate section 29 is referred to as a “joining portion B”. Description will be given in detail below of a position of the joining portion B.

The joining portion B is disposed below the upper end surface 27 of the tubular section 11 along the central axis P, as is illustrated clearly in FIG. 4. Moreover, as illustrated in FIG. 3, the joining portion B is disposed above the lower end 15b of the spring pin 15 along the central axis P. In other words, the joining portion B is disposed so as to overlap with the spring pin 15 along the central axis P. The plate section 29 serves as a wall defining a crankshaft chamber 72 into which the crankshaft 71 is inserted.

The joining portion B also extends over a larger area in the peripheral direction Q. Specifically, as illustrated in FIG. 2, the joining portion B has a length in the peripheral direction Q of approximately one third of an entire periphery of the tubular section 11, for example. In other words, assuming that the joining portion B is an arc about the central axis P, the joining portion B has a central angle of approximately 120 degrees, for example.

The boss 25 is parallel or substantially parallel to the central axis P, which differs from the plate section 29. Moreover, a portion joining the boss 25 and the tubular section 11 is parallel or substantially parallel to the central axis P, whereas the joining portion B is substantially orthogonal to the central axis P. This causes a difference between the boss 25 and the plate section 29. The area within which the boss 25 projects reaches the upper end surface 27 of the tubular section 11. This also causes a difference between the boss 25 and the plate section 29.

The first groove 23 described above is disposed in the peripheral direction Q within an area facing the joining portion B across the central axis P. Specifically, the area of the first groove 23 corresponds to an area on the inner wall 21 enclosed by points C1 and C2 in FIG. 2. More preferably, the first groove 23 is disposed on an area of the inner wall facing the inner wall corresponding to a center portion of the joining portion B in the peripheral direction Q.

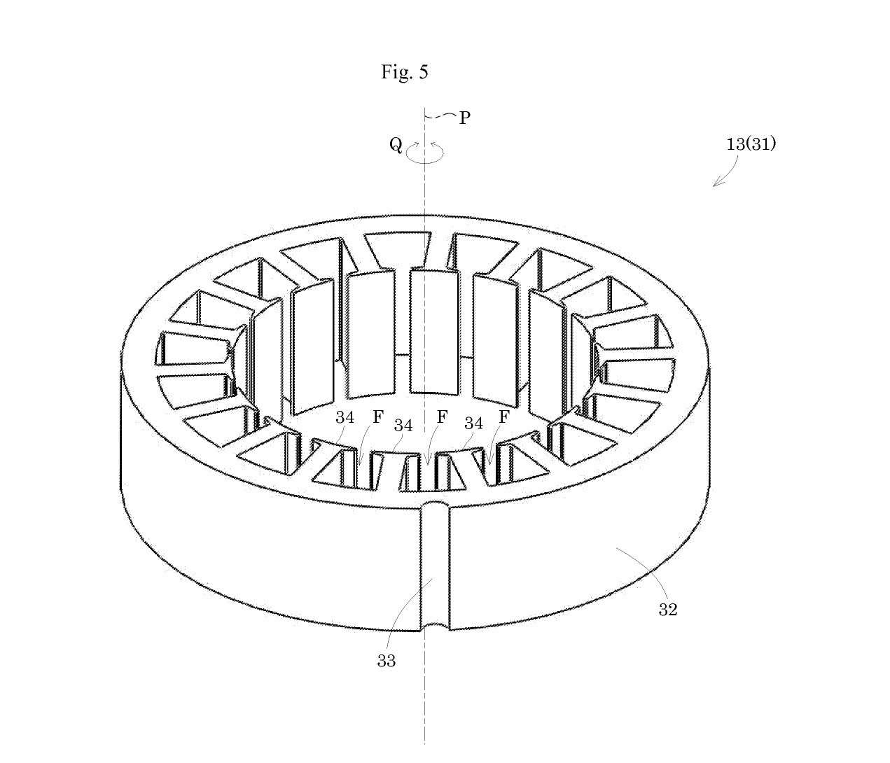

As illustrated in FIG. 3, the stator 13 includes a stator core 31, insulated bobbins 35, and coils 37. FIG. 5 is a perspective view of a principal portion of the stator. As illustrated, a second groove 33 is provided on an outer wall 32 of the stator core 31, the second groove 33 being parallel or substantially parallel to the central axis P. The second groove 33 has a semicircular or substantially semicircular shape. The stator core 31 further includes a plurality of teeth 34. A slot F is provided between adjacent teeth 34. The second groove 33 is disposed radially outside of the slot F.

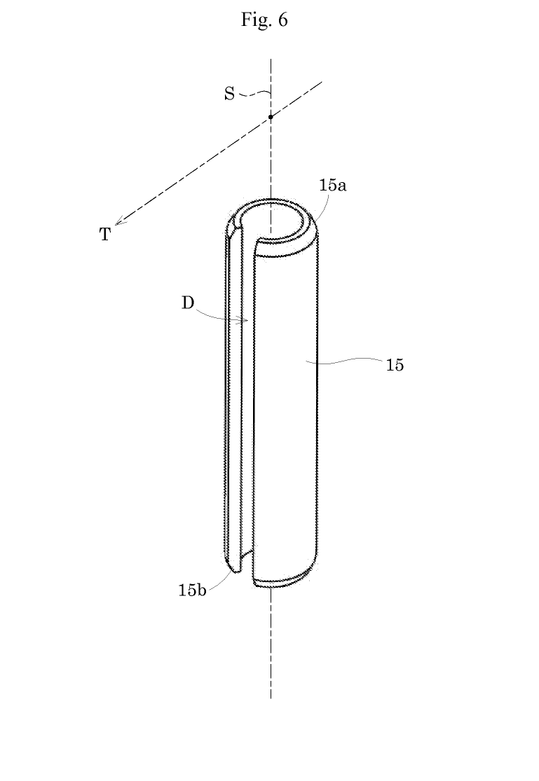

FIG. 6 is an external perspective view of the spring pin 15. As illustrated, the spring pin 15 is cylindrical or substantially cylindrical, and includes a slit D parallel or substantially parallel to a shaft axis S thereof. An upper end 15a and a lower end 15b of the spring pin 15 are preferably chamfered. The ends are each preferably tapered. When the spring pin 15 is compressingly deformed radially and inwardly toward the shaft axis 5, the spring pin 15 exerts a radial elastic force outwardly relative to the shaft axis S.

Description will be given in detail of a fixed structure for use in the driving unit 1 according to a preferred embodiment of the present invention. FIG. 7 is an exploded perspective view of a principal portion of the driving unit 1. As illustrated, the stator 13 is firstly attached to the tubular section 11 such that the second groove 33 faces the first groove 23. This provides a circular or substantially circular gap defined by the first groove 23 and the second groove 33. Subsequently, the spring pin 15 is pressed into the gap.

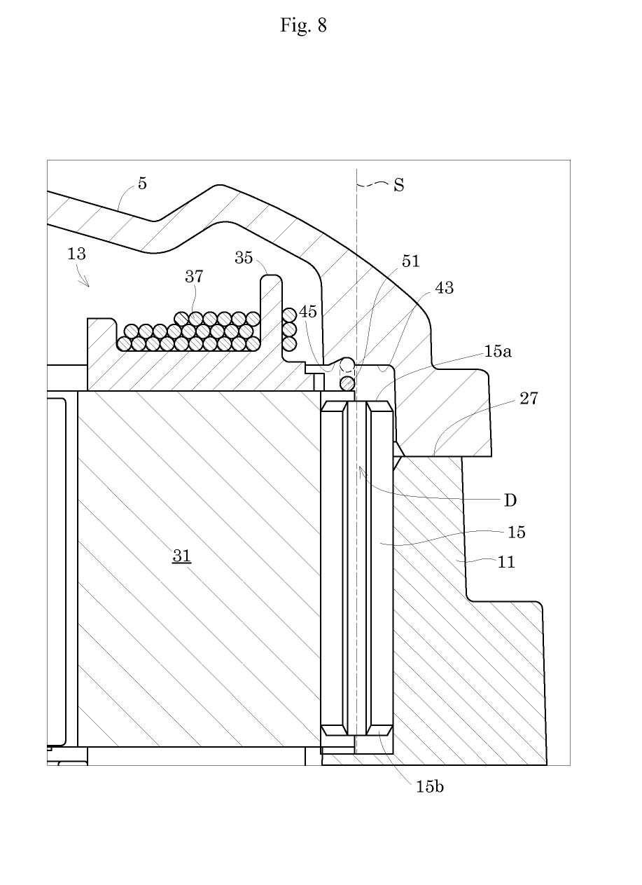

FIG. 8 is an enlarged sectional view of the stator-fixed structure. As illustrated, the spring pin 15 has the shaft axis S parallel or substantially parallel to the central axis P, and is maintained compressingly deformed. The slit D becomes narrower as the spring pin 15 is compressingly deformed. However, the slit D is designed not to be blocked (i.e., the spring pin 15 is not closed) although the spring pin 15 is maintained compressingly deformed.

Reference is again made to FIG. 2. The spring pin 15 is pressed while being adjusted such that a direction of the slit D conforms to a tangent line to the second groove 33 of the stator 13. More strictly speaking, assuming that a radial direction connecting the shaft axis S of the spring pin 15 to the slit D is a slit direction T (see also FIG. 6), a radial direction relative to the central axis P through the shaft axis S is a radial direction V, and a direction orthogonal to the radial direction V is a tangent line direction W (see FIG. 2), the spring pin 15 is disposed such that the slit direction T is parallel or substantially parallel to the tangent line direction W. In other words, the radial direction V relative to the central axis P through the shaft axis S of the spring pin 15 is substantially orthogonal to the direction T connecting the shaft axis S to the slit. This exerts an elastic force of the spring pin 15 on the stator 13. In addition, a force direction of the spring pin 15 exerted on the stator 13 corresponds or substantially corresponds to a direction from the shaft axis S of the spring pin 15 toward the central axis P (i.e., the radial direction V). Moreover, the shaft axis S of the spring pin 15 is parallel or substantially parallel to the central axis P, and thus variations in pressing the spring pin 15 against the stator 13 along the central axis P is suitably prevented or reduced. That is, the spring pin 15 presses the stator 13 with a substantially uniform force regardless of the position thereof along the central axis P.

The spring pin 15 presses the second groove 33 of the stator core 31 to press an opposite portion of the stator 13 against the inner wall 21. Specifically, the stator 13 is brought into surface contact to the inner wall 21 within an area extending in the peripheral direction Q around a point C3 where the radial direction V and the inner wall 21 intersect.

The inner wall 21 in surface contact with the stator 13 undergoes a load radially and outwardly relative to the central axis P. This causes a friction force between the stator 13 and the inner wall 21. The friction force holds the stator 13. That is, shifting of the stator 13 along the central axis P is suitably prevented or reduced.

Moreover, the inner wall 21 in surface contact with the stator 13 serves as a joining portion B at the external surface (back surface) thereof. As described above, the portion of the tubular section 11 serving as the joining portion B has a higher rigidity than the other portions of the tubular section 11, and thus the tubular section 11 is difficult to deform and bend. Consequently, radial shifting of the stator 13 along the central axis P is suitably prevented or reduced.

For instance, comparison is made with respect to a comparative example in which a first groove 23 is disposed in an opposite position to the above preferred embodiments, i.e., a point C3. In this comparative example, the spring pin presses the stator 13 against a portion of the tubular section 11 away from the joining portion B (i.e., an area around the first groove 23 of the above preferred embodiments). As described above, the portion of the tubular section 11 away from the joining portion B is deformed more easily than the portion of the tubular section 11 serving as the joining portion B. If the portion is deformed, an overall diameter of the inner wall 21 in surface contact with the stator 13 increases relative to the central axis P. As a result, the stator 13 radially shifts as the tubular section 11 is deformed. As described above, compared to the comparative example, the fixed structure of the preferred embodiments described above prevents or reduces radial shifting of the stator 13.

In the adopted fixed structure of the preferred embodiments described above, the first groove 23 undergoes a load radially and outwardly relative to the central axis P from the spring pin 15. On the other hand, an area of the first groove 23 undergoing the load is smaller than that of the inner wall 21 undergoing a load from the stator 13. That is, the inner wall 21 away from the first groove 23 in the peripheral direction Q undergoes no radial and outward load. The portions of the tubular section 11 on both beside the first groove 23 undergo a pulling force toward the first groove 23. Here, the force does not act so as to efficiently expand and extend the diameter of the inner wall 21 in terms of its direction. Consequently, if the portion of the tubular section 11 corresponding to the first groove 23 is deformed to increase its diameter, the inner wall 21 on both beside the first groove 23 makes it difficult to increase its diameter. This also results in difficulty in radial shifting of the stator 13. As noted above, in the fixed structure of the preferred embodiments described above, although the portion of the tubular section 11 corresponding to the first groove 23 may be deformed, the stator 13 is difficult to shift radially.

Description will be given next of other characteristics of the fixed structure. Reference is now made to FIG. 3. The top surface of the stator 13(stator core 31) projects upward over the upper end surface 27 of the tubular section 11. Consequently, the tubular section 11 is designed to have a depth (i.e., a dimension from the upper end surface 27 to the top surface of the flange 24) shorter than a dimension of the stator 13 (stator core 31) along the central axis P.

The upper end 15a of the spring pin 15 preferably does not project upward over the top surface of the stator 13 (stator core 31). The spring pin 15 is designed to have a length shorter than the dimension of the stator 13 along the central axis P. Consequently, since the spring pin 15 does not project over the stator 13, interference between the spring pin 15 and the stator 13 or other elements is suitably prevented or reduced. On the other hand, the spring pin 15 projects upward over the upper end surface 27 of the tubular section 11.

In the fixed structure of the preferred embodiments described above, the joining portion B is disposed so as to overlap the spring pin 15 along the central axis P. This prevents or reduces deformation of the tubular section 11.

The spring pin 15 presses the outer wall 32 of the stator 13. Accordingly, although the stator 13 (stator core 31) may have variations in dimensions along the central axis P, the stator 13 is pressed against the inner wall 21 with no influence from the variations.

The elastically deformable spring pin 15 is used as the fixing member. Accordingly, although there may occur variations in the internal diameter of the inner wall 21 or in dimensions of the first groove 23 of the tubular section 11, in the external diameter of the stator 13 (stator core 31) or in dimensions of the second groove 33, the variations are absorbed to permit the stator 13 to be suitably pressed against the inner wall 21. Furthermore, the spring pin 15 is a relatively compact elastic body. This achieves a reduction in the size of the first groove 23 and the second groove 33. Consequently, a reduction in the size of the tubular section 11 and the stator 13 is achieved.

The joining portion B preferably has a length in the peripheral direction Q of approximately one-third the entire periphery of the tubular section 11, for example. This achieves an enhanced rigidity of the tubular section. This also achieves an increased contact area of the stator 13 to the inner wall 21.

The stator 13 includes the second groove 33. This allows the spring pin 15 to suitably press the stator 13. This also prevents or reduces in one operation shifting of the stator 13 in the peripheral direction Q.

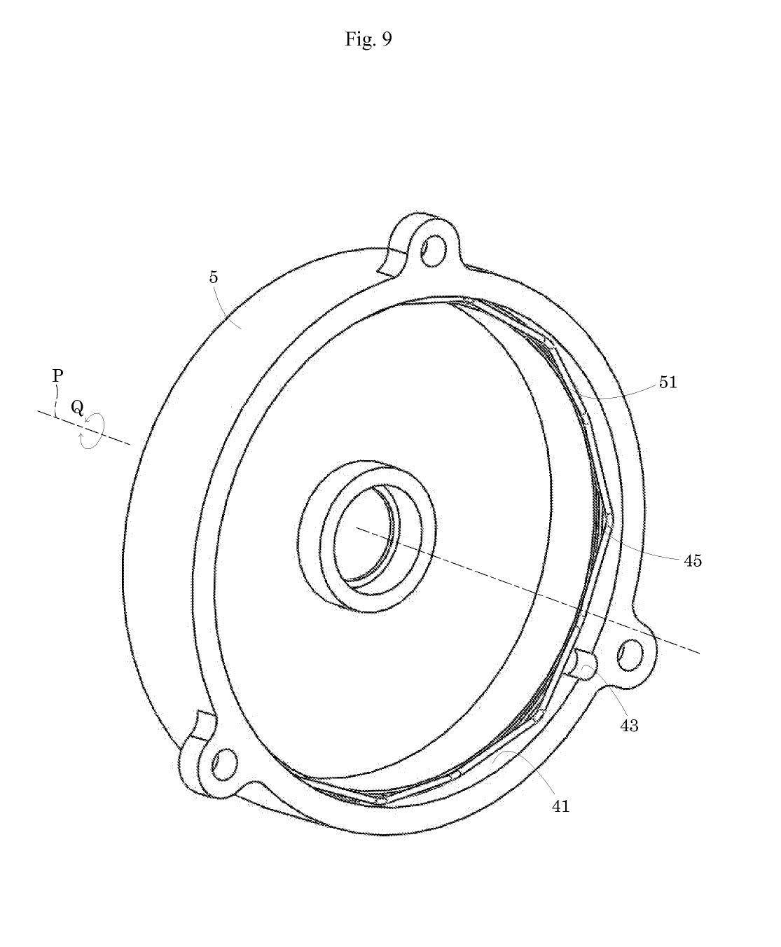

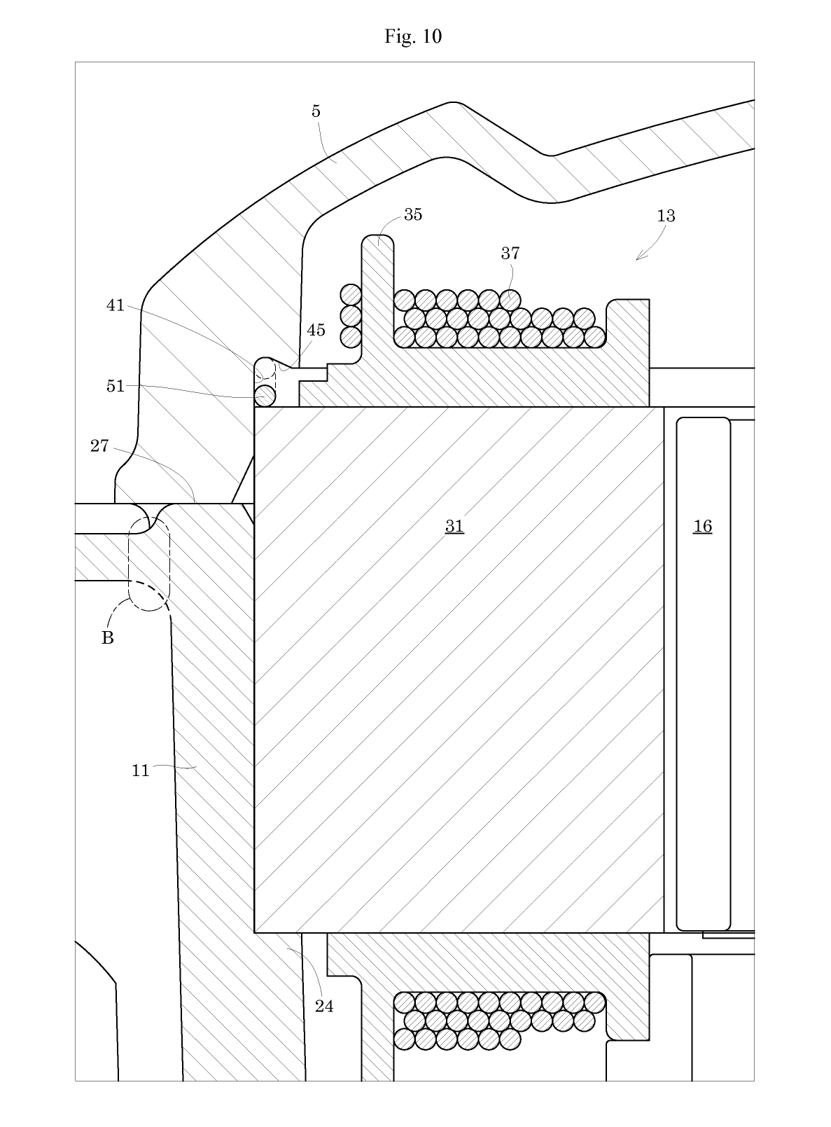

Description will be given next of the other elements of the driving unit 1 according to a preferred embodiment of the present invention. Reference is made to FIGS. 9 and 10. FIG. 9 is a perspective view of the rear surface of the cover 5. FIG. 10 is an enlarged sectional view of a second stator-fixed structure. The rear surface of the cover 5 includes a side wall 41 therein. The side wall 41 extends in the peripheral direction Q relative to the central axis P. The side wall 41 has an internal diameter slightly larger than the external diameter of the stator 13. The stator 13 (stator core 31) projecting from the tubular section 11 is accommodated in the side wall 41. As noted above, the upper stator 13 is partially accommodated in the cover 5, facilitating a reduction in the size of the driving unit 1.

As illustrated in FIGS. 8 and 9, the side wall 41 includes a notch 43 therein. The notch 43 is disposed along an extended position of the first groove 23. The spring pin 15 is accommodated in the notch 43, the spring pin 15 projecting upward from the upper end surface 27 of the tubular section 11.

The cover 5 also includes a protrusion 45. The protrusion 45 projects radially and inwardly from an upper end of the side wall 41. The protrusion 45 is preferably inclined downwardly along the central axis P toward inside of the central axis P radially. As a result, an annular recess (space) is provided between the side wall 41 and the protrusion 45.

The driving unit 1 further includes a bent wire rod 51 between the cover 5 and the stator 13. The bent wire rod 51 rests on the side wall 41 and the protrusions 45 described above. The bent wire rod 51 also directly contacts the periphery of the top surface of the stator core 31. The bent wire rod 51 applies an elastic force to the stator 13 downwardly along the central axis P.

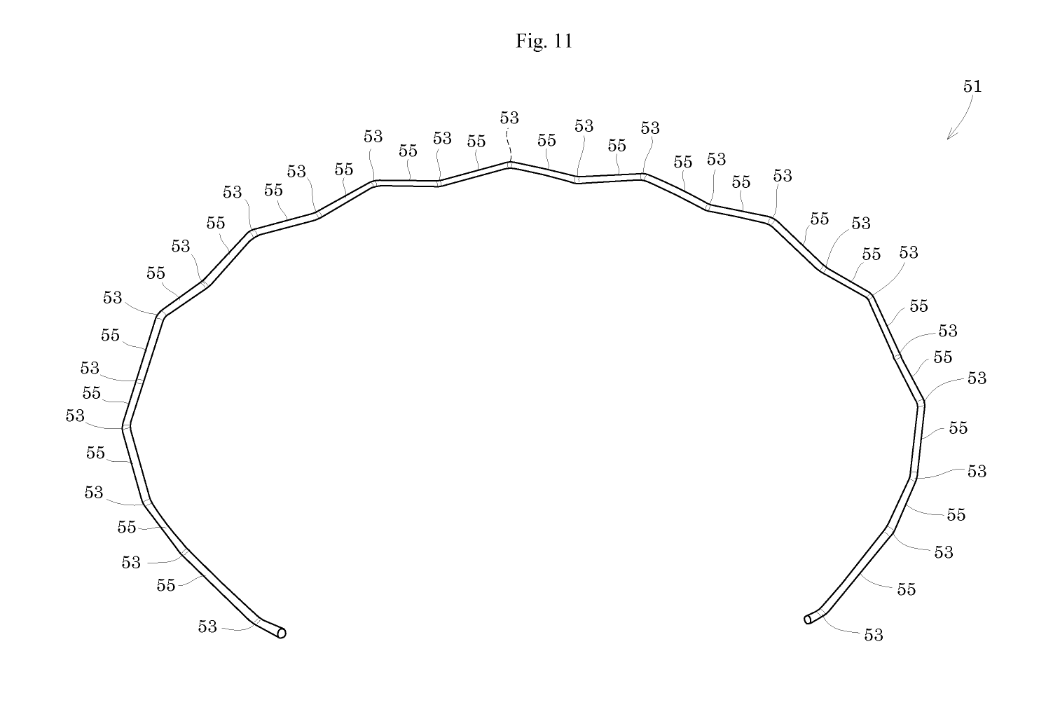

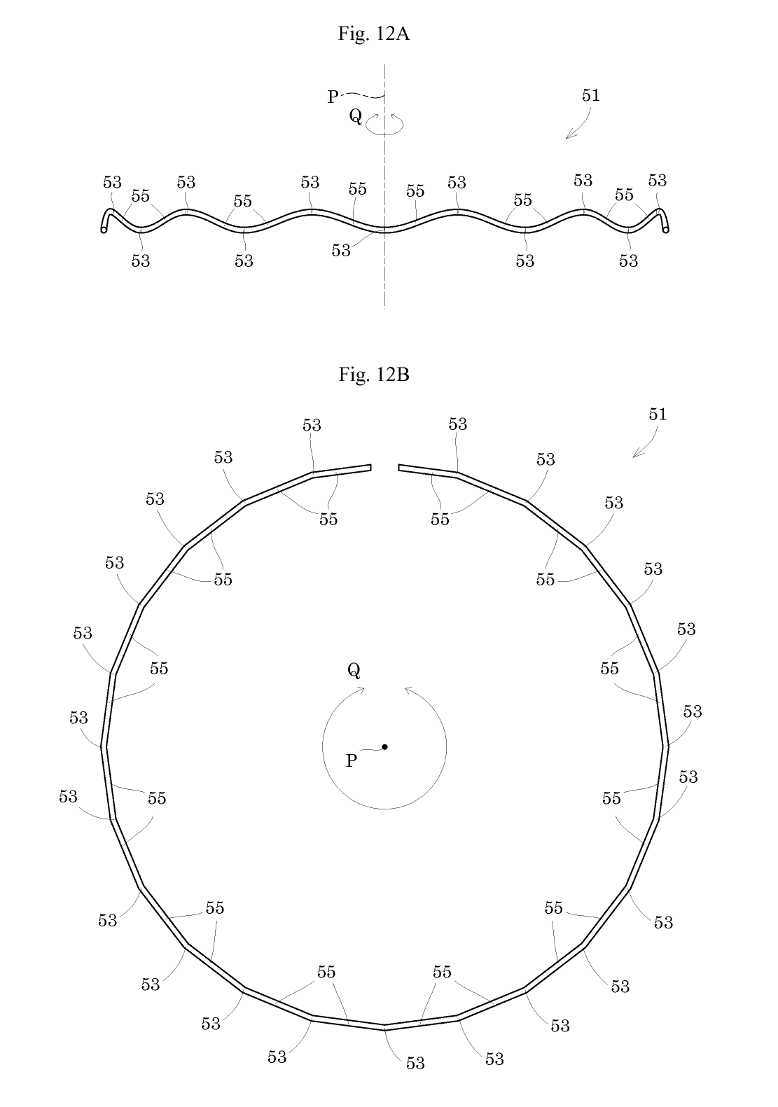

FIG. 11 is a perspective view of the bent wire rod 51. FIG. 12A is a partial side view of the bent wire rod 51, and FIG. 12B is a plan view of the bent wire rod 51. FIG. 11 illustrates a bent wire rod 51 that is not compressingly deformed, whereas FIG. 12 illustrates a bent wire rod 51 compressingly deformed between the cover 5 and the stator 13.

The bent wire rod 51 is defined by a single wire such as round steel. As illustrated in FIG. 12A, the bent wire rod 51 includes a plurality of bent portions 53 and a plurality of straight portions 55. The bent portions 53 are formed preferably by bending the wire so as to be preferably zigzag with alternate projections and depressions arranged successively and vertically along the central axis P in a side view. The straight portions 55 are formed preferably by extending the wire rod straightly to connect the adjacent bent portions 53. Moreover, as illustrated in FIG. 12B, the bent wire rod 51 bends at the bent portions 53 so as to have a polygonal or substantially polygonal outer shape (e.g., equilateral icositetragon) in a plan view. The polygonal or substantially polygonal shape includes vertices defined by each of the bent portions 53 and an opened portion. The bent wire rod 51 is designed in advance so as to have an outer shape larger than the external diameter of the stator 13 in a plan view.

The bent wire rod 51 described above includes the bent portions 53 alternately projecting vertically along the central axis P. When the bent wire rod 51 is compressed along the central axis P, an elastic force is generated by which the bent wire rod 51 tends to expand along the central axis P to cause the bent wire rod 51 to return to its original shape. When the bent wire rod 51 is compressed radially and inwardly relative to the central axis P to have a smaller outer shape, an elastic force is generated by which the bent wire rod 51 tends to expand radially and outwardly to cause the bent wire rod 51 to return to its original shape.

Description will be provided now of a second fixed structure included in the driving unit 1 according to a preferred embodiment of the present invention. As illustrated in FIG. 9, the bent wire rod 51 is attached along the side wall 41 of the cover 5 while being compressed so as to have a smaller outer shape. Then the bent wire rod 51 generates a radial outward elastic force. With the elastic force, the bent wire rod 51 expands in the peripheral direction of the side wall 41 to rest on the side wall 41. Subsequently, the cover 5 is fastened to the housing 3.

Reference is now made to FIG. 10. When the cover 5 is connected to the housing 3, the bent portions 53 projecting downward along the central axis P contact the peripheral edge of the stator 13 (stator core 31). The bent portions 53 projecting upward along the central axis P contact the protrusions 45. The bent portions 53 are held while being compressed along the central axis P. Accordingly, the bent wire rod 51 exerts an elastic force to the stator 13 downwardly along the central axis P. That is, the bent wire rod 51 presses the stator 13 along the central axis P in a direction away from the cover 5. Consequently, the lower surface of the stator 13 is pressed against the flange 24.

The second fixed structure combined with the fixed structure described above further prevents or reduces shifting of the stator 13 along the central axis P.

Moreover, as mentioned above, the spring pin 15 does not project above the stator 13 (stator core 31), thus preventing or reducing interference between the spring pin 15 and the bent wire rod 51.

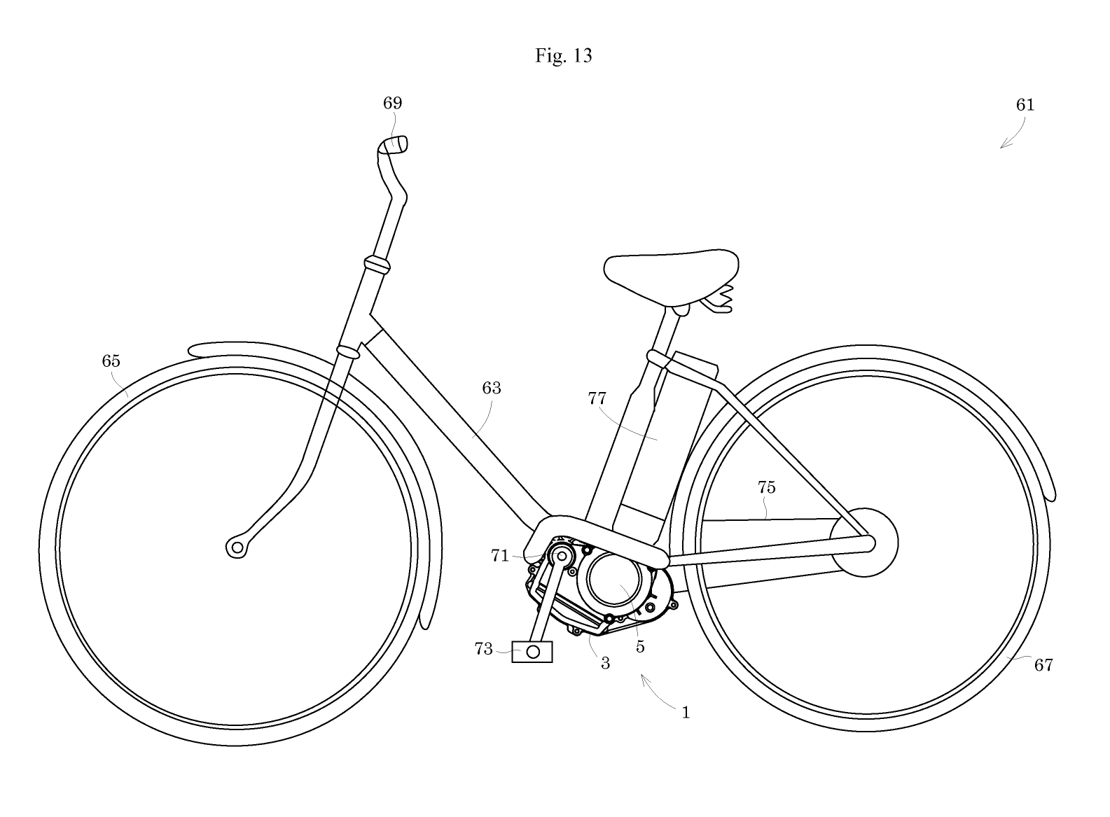

Description will be provided next of an exemplary application of the driving unit 1 to a bicycle according to a preferred embodiment of the present invention. FIG. 13 is a left side view of a bicycle 61 with the driving unit 1 mounted thereon. The bicycle 61 includes a vehicle frame 63, a front wheel 65 and a rear wheel 67 rotatably supported on the vehicle frame 63, and a handle 69 supported on the vehicle frame 63 to steer the front wheel 65.

The driving unit 1 is supported on the vehicle frame 63 around the lower middle portion of the bicycle 61. The driving unit 1 is arranged such that the central axis P of the tubular section 11 is horizontal or substantially horizontal. The driving unit 1 includes a crankshaft 71 passing therethrough horizontally or substantially horizontally. The crankshaft 71 has pedals 73 coupled thereto on both ends thereof. Pressure on the pedals 73 causes the crankshaft 71 to rotate. Rotary power of the crankshaft 71 is transmitted to the rear wheel 67 via a chain 75. In addition, the vehicle frame 63 includes a battery 77 supported thereon. The battery 77 drives the motor 18 defined by the stator 13 and the like.

Reference is now made to FIG. 3. The crankshaft 71 is inserted into the crankshaft chamber 72 of the driving unit 1. The crankshaft chamber 72 also includes a torque sensor (not shown) that detects torque of the crankshaft 71, and a controller (not shown) that controls the motor 18. Power from the motor 18 is output to an output shaft 20. The rotary power from the output shaft 20 is transmitted to the rear wheel 67 via the chain 75 mentioned above.

The controller is programmed to control the motor 18 in accordance with detection results from the torque sensor. The motor 18 generates power in accordance with pressure on the pedals 73. The pressure on the pedals 73 and the power from the motor 18 are transmitted to the chain 75 via the crankshaft 71 and the output shaft 20, respectively. The chain 75 combines the pressure on the pedals 73 and the power from the motor 18 to transmit the combined pressure and power to the rear wheel 67. This causes the bicycle 61 to move.

In the bicycle 61, the pedals 73 often contact the ground first. The pedals 73 are coupled to the crankshaft 71. Accordingly, the surface of the driving unit (the outer surface of the housing) of the bicycle 61 may undergo shock directly, or the interior of the driving unit (crank chamber) may undergo shock directly through the crankshaft. When shock is directly transmitted inside of the driving unit, a strong force is transmitted to the stator along the central axis P. On the other hand, in the driving unit 1 according to a preferred embodiment of the present invention, the fixed structure and/or the second fixed structure described above of the stator 13 is/are used. This suitably prevents or reduces shifting of the stator 13 along the central axis P. Consequently, the driving unit 1 according to a preferred embodiment of the present invention is suitable to mount on the bicycle 61.

The present invention is not limited to the above preferred embodiments, but may be modified as under.

The preferred embodiments described above uses both the fixed structure and the second fixed structure. Alternatively, the second fixed structure may be omitted.

In the preferred embodiments described above, the stator 13 includes the second groove 33. Alternatively, the second groove 33 may be omitted. In this case, the spring pin 15 may be modified to be pressed into the first groove 23 only. Such a modification allows the spring pin 15 to suitably press stator 13 against the inner wall 21, achieving suitable prevention of the stator 13 from shifting along the central axis P.

In the preferred embodiments described above, the gap defined by the first groove 23 and the second groove 33 has a circular or substantially circular shape, but the shape of the gap is not limited to this. For instance, the gap may be made rectangular or substantially rectangular or elliptical or substantially elliptical.

In the preferred embodiments described above, the joining portion B has a length in the peripheral direction Q of approximately one-third the entire periphery of the tubular section 11, but this is not limitative. That is, the length can be modified as appropriate. For instance, the joining portion B has a length in the peripheral direction Q of approximately one-third or more, or of approximately one-third or less. Alternatively, the joining portion B has a length in the peripheral direction Q of one-fourth or more, for example.

In the preferred embodiments described above, the plate section 29 serves as the wall of the crankshaft chamber 72, but this is not limitative. The plate section 29 may be modified so as to have other functions. Alternatively, the plate section 29 may be modified to simply form the joining portion B to have only a function of enhancing the rigidity of the tubular section 11.

In the preferred embodiments described above, the second groove 33 is disposed radially outside of the slot F, but is not limited to this. The second groove 33 may be modified and selected as appropriate. For instance, the second groove 33 may be disposed radially outside of the teeth 34.

The preferred embodiments described above describe as one example the spring pin 15 as the fixing member. This, however, is not limitative. For instance, the fixing member may be a rigid body with no elasticity. Specifically, the fixing member may be modified to be a wedge, a tapered pin, a parallel pin, or the like. In addition, the shape of the pin is not limited to be cylindrical. For instance, the shape may be modified into a columnar shape as such a polygonal column or a conical shape such as a cone or a pyramid.

The preferred embodiments described above are applicable not only to the driving unit 1 mounted on the bicycle 61 but also to any vehicle or device. The crankshaft chamber 72 may be omitted with the modification above.

In the preferred embodiments described above, the stator 13 has been described as one example of an element of the motor 18, but the present invention is not limited to this. For instance, the preferred embodiments of the present invention are applicable to a stator 13 defining a generator.

In the preferred embodiments described above, the bent wire rod 51 has been described as one example of the elastic member, but the present invention is not limited to this. The bent wire rod 51 may be another type of elastic body or a machine element such as a spring.

The preferred embodiments and modifications described above may be modified as appropriate. For instance, each construction may be modified as appropriate by replacing or combining it with other modifications.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-16. (canceled)

17. A stator-fixed structure comprising:
a stator;
a housing including a tubular section accommodating the stator with a first groove provided on an inner wall thereof; and
a fixing member fixing the stator to the housing by being pressed into the first groove to press the stator against the inner wall of the tubular section; wherein
the housing further includes a plate section having a planar shape orthogonal or substantially orthogonal to a central axis of the tubular section and projecting from an outer surface of the tubular section;
a portion connecting the tubular section and the plate section defines a joining portion; and
the first groove is disposed in a peripheral direction of the tubular section within an area facing the joining portion across the central axis.

18. The stator-fixed structure according to claim 17, wherein the joining portion overlaps the fixing member along the central axis.

19. The stator-fixed structure according to claim 17, wherein the joining portion is disposed below an upper end surface of the tubular section along the central axis.

20. The stator-fixed structure according to claim 17, wherein the joining portion has a length in the peripheral direction of the tubular section of about one-fourth or more of an entire periphery of the tubular section.

21. The stator-fixed structure according to claim 17, wherein the fixing member has a columnar shape, and is pressed into the first groove with a shaft axis of the fixing member being parallel to the central axis.

22. The stator-fixed structure according to claim 21, wherein the fixing member is cylindrical.

23. The stator-fixed structure according to claim 21, wherein the fixing member is a spring pin with a slit provided therein.

24. The stator-fixed structure according to claim 23, wherein a radial direction relative to the central axis through the shaft axis of the spring pin is orthogonal or substantially orthogonal to a direction connecting the shaft axis to the slit.

25. The stator-fixed structure according to claim 17, wherein the fixing member has a length shorter than that of the stator along the central axis.

26. The stator-fixed structure according to claim 17, wherein the stator includes a second groove on an outer wall thereof, and is accommodated in the tubular section such that the second groove faces the first groove, and the fixing member is pressed into a gap defined by the first groove and the second groove.

27. The stator-fixed structure according to claim 17, further comprising:
a cover coupled to the housing to block an opening of the tubular section; and
an elastic member disposed between a top surface of the stator and a rear surface of the cover to press the stator along the central axis and away from the cover.

28. The stator-fixed structure according to claim 27, wherein the tubular section includes a plurality of bosses projecting radially and outwardly from an upper end surface of the tubular section to connect the tubular section to the cover, and the first groove is disposed adjacent to one of the plurality of the bosses.

29. The stator-fixed structure according to claim 28, wherein the top surface of the stator projects above the upper end surface of the tubular section, and the cover includes therein a notch provided along an extended position of the first groove.

30. A driving unit comprising;
a motor configured to generate power, the motor including a rotor and a stator on an outer periphery of the rotor;
a housing including a tubular section accommodating the motor, the tubular section including a first groove on an inner wall thereof; and
a fixing member configured to fix the stator to the housing by being pressed into the first groove to press the stator against the inner wall of the tubular section; wherein
the housing further includes a plate section having a planar shape orthogonal or substantially orthogonal to a central axis of the tubular section and projecting from an outer surface of the tubular section;
a portion connecting the tubular section and the plate section defines a joining portion; and
the first groove is disposed in a peripheral direction of the tubular section within an area facing the joining portion across the central axis.

31. The driving unit according to claim 30, wherein the driving unit is mounted on a bicycle, the housing further includes a crankshaft chamber into which a crankshaft of the bicycle is inserted, and the motor generates power to assist pressure on pedals coupled to the crankshaft.

32. The driving unit according to claim 31, wherein the plate section is a wall defining the crankshaft chamber.
